(19) United States
(12) Patent Application Publication
(10) Pub. No.: US 2009/0070941 A1
(43) Pub. Date: Mar. 19, 2009

(54) INFLATABLE BED ASSEMBLY

(76) Inventor: Vincent W.S. Lau, Sai Kung (HK)

Correspondence Address: SCHWEITZER CORNMAN GROSS & BONDELL LLP, 292 MADISON AVENUE - 19th FLOOR, NEW YORK, NY, 10017, US

(21) Appl. No.: 11/856,848

(22) Filed: Sep. 18, 2007

(51) Int. Cl. A47C 27/08; A47C 27/00; B23P 19/04

(52) U.S. Cl. 5/706; 29/700; 5/655.3

(57) ABSTRACT

An inflatable bed assembly having an inflexible cover that has one or more inflatable body support enclosures to receive one or more inflatable mattresses in a fully or nearly fully deflated state through a slit. Each mattress has a valve which is aligned with valve openings of the inflatable body support enclosures allowing them to be inflated while they are within the cover. The cover has internal dimensions that is less than or substantially equal to the corresponding external dimensions of the maximally inflated mattresses to restrict the inflatable mattresses from expanding. The bed is enhanced by inserting padding in a removable mattress padding enclosure attached to the top of the first inflatable body support enclosure.

### FIELD OF THE INVENTION

The invention pertains to the field of inflatable beds.

### BACKGROUND OF THE INVENTION

Inflatable beds are popular because they are portable and have a relatively low cost compared to beds with traditional mattresses. However, prior inflatable beds are found by many people to be unsuitable for every day use because they fail to provide as much support and comfort as a bed with a traditional mattress.

Inflatable beds and inflatable mattresses known in the art are typically made out of relatively thin vinyl or another elastic or semi-elastic material. The amount of support provided by a traditional air bed is a function of the amount of air (and air pressure) in the bed. However, overpressurization of a traditional air bed may cause warping or breakage of the panels or seams of the inflatable mattress. Therefore, the amount of support a traditional inflatable bed can provide is limited by the maximum amount of air pressure the bed can reliably withstand while maintaining the structural integrity of the inflatable bed. The result is that when a person places their weight on a prior art inflatable bed, the inflatable bed may sag an undesirable amount and fail to firmly support the person's body. The inability of an inflatable bed to provide firm support renders air mattresses unsuitable or undesirable for daily use.

Therefore it is desired to provide an inflatable bed that provides firm support equal to the support provided by a traditional mattress. Furthermore, it is desired to provide an inflatable bed that is firm yet has a top portion that is soft in order to increase the comfort of the bed.

Therefore, it is an object of the invention to provide an inflatable bed that has a firm level of support equal to the support provided by a traditional mattress.

It is another object of the present invention to provide an inflatable bed that provides a firm level of support equal to the support provided by a traditional mattress that has a soft top for increased comfort.

Yet another object of the present invention is to provide an inflatable bed that is suitable for everyday usage.

Still a further object of the present invention is to provide an inflatable bed cover that is adapted to provide a firm level of support.

Another object of the present invention is to provide a method for assembling an inflatable bed that provides a firm level of support equal to the support provided by a traditional mattress.

It is another object of the present invention to provide an inflatable bed with a firmness that is equal to the support provided by a traditional mattress that is economical to manufacture.

### SUMMARY OF THE INVENTION

The foregoing objects are met by the present invention directed to an improved inflatable bed. The improved inflatable bed features a cover having a first inflatable body support enclosure. The first inflatable body support enclosure has top and bottom panels, first and second opposed side panels, first and second opposed end panels, and a first inflation valve opening.

The cover is adapted to receive one or more inflatable mattresses forming an inflatable body support. The inflatable mattresses have inflation valves to receive air, water or another fluid or gas. The first inflatable body support enclosure is adapted to receive one or more inflatable mattresses. A slit is formed on one of the panels of the first inflatable body support enclosure. The slit is elongated to permit the insertion and removal of inflatable mattresses. The inflatable bed in one embodiment has a first inflatable mattress which is inserted through the slit in the enclosure in a fully or nearly fully deflated state.

In another embodiment, the first inflatable mattress is placed near the top of the cover and a second inflatable mattress is placed in the cover below the first mattress. Alternatively, the second inflatable mattress may be inserted into a second inflatable body support enclosure of the cover. The second inflatable body support enclosure has top and bottom panels, first and second opposed side panels, first and second opposed end panels, and a second inflation valve opening. The second inflatable body support enclosure also has a slit adapted to receive the second inflatable mattress in a fully or nearly fully deflated state on one of the panels. The first and second inflatable body support enclosures are releasably attached to each other.

The inflation valves on the inflatable mattresses are aligned with inflation valve openings in the mattress cover in order to allow access to the inflatable mattress valves such that the mattresses may be inflated and deflated while they are within the mattress cover. Inflation valve opening covers connected to the cover are adapted to be placed over the inflation valve openings in order to protect the inflation valves, the inflatable mattresses, and the interior of the mattress cover from being damaged or soiled.

The mattress cover is constructed out of inelastic materials such as textiles and/or inelastic polymers. It is particularly desirable that each of the internal dimensions (e.g., internal length, width, and height) of the cover is less than or substantially equal to the corresponding external dimensions of the maximally inflated mattresses. Therefore, the cover forms an inflatable body support confining volume which restricts the inflatable mattresses from expanding beyond the dimensions of the cover when the inflatable mattresses are inflated. The inflatable mattresses of the improved inflatable bed are able to receive a larger amount of air pressure than traditional (non-confined) airbeds and the airbed provides a firmness equivalent to that of a traditional mattress when the inflatable mattresses are fully inflated.

In order to enhance the comfort level of the airbed, the cover has a mattress padding enclosure on the top portion of the cover for receiving a mattress padding. The mattress padding enclosure is releasably attached to the first inflatable body support enclosure. The mattress padding enclosure has a selectively closeable opening having a length suitable to permit insertion and removal of the mattress padding.

The inflatable bed has a channel around a periphery of a side of the inflatable bed between the first and second inflatable body support enclosures. This channel allows a conventional fitted sheet to be securely placed over the first inflatable body enclosure and mattress padding enclosure.

### DESCRIPTION OF THE DRAWINGS

The above and other objects, features and advantages of the present invention will become apparent from the following description of a preferred but, nonetheless, illustrative embodiment of the invention, taken in conjunction with the accompanying drawings, wherein:

FIG. 1 provides an exploded view of a first embodiment of the inflatable bed assembly;

FIG. 2 provides a top perspective view of the inflatable bed assembly of FIG. 1;

FIG. 3 provides a bottom perspective view of the inflatable bed assembly of FIG. 1;

FIG. 4 provides a side elevation sectional view of the inflatable bed assembly of FIG. 1;

FIG. 5 provides a front elevational view of the inflation valve opening covers on the mattress cover of the inflatable bed assembly of FIG. 1;

FIG. 6 provides a side elevation sectional view of a second embodiment of the inflatable bed assembly;

FIG. 7 provides a side elevation sectional view of the inflatable bed assembly of FIG. 6 with a sheet placed over the first inflatable body support enclosure; and

FIG. 8 provides a bottom perspective view of the second inflatable body support enclosure of the inflatable bed assembly of FIG. 6.

### DETAILED DESCRIPTION OF THE PREFERRED EMBODIMENTS

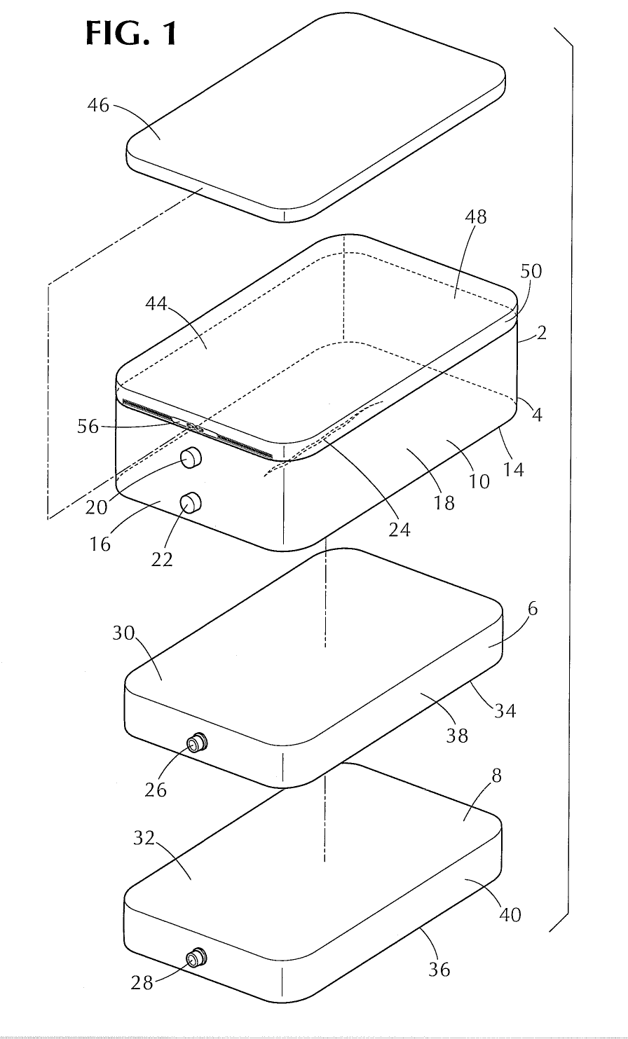

With particular reference to the drawings, the present invention is directed to an improved inflatable bed assembly 2 and method therefor. Referring to FIG. 1, a first embodiment of the inflatable bed assembly 2 has a cover 4 and has first and second inflatable mattresses 6, 8 which form an inflatable body support within the cover 4.

The cover 4 has an inflatable body support enclosure 10 for receiving the inflatable mattresses 6, 8. The inflatable body support enclosure 10 has a top 12 and bottom 14 panel, first and second side panels 18, first and second opposed end panels 16, and first and second inflation valve openings 20, 22.

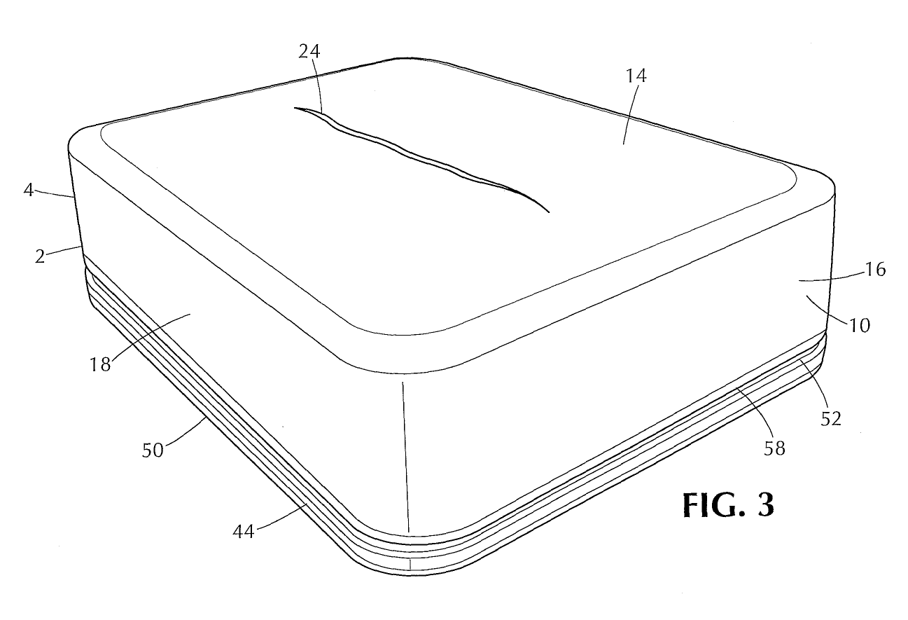

As shown in FIG. 3, the inflatable body support enclosure 10 also has an elongated slit 24 on one of its panels. In the displayed embodiment, the slit 24 is on the bottom panel 14. However, the slit 24 may be on any of the other panels of the inflatable body support enclosure 10. The elongated slit 24 is long enough to permit the insertion and removal of the inflatable mattresses 6, 8 in a fully deflated or nearly fully deflated state. For example, the length of the elongated slit 24 may be 50-75% of the length of the inflatable mattresses 6, 8 (e.g., the longest dimension) to allow the inflatable mattresses to be easily inserted and removed from the inflatable body support enclosure 10.

The inflatable body support enclosure 10 is constructed of an inflexible material. Examples of a suitable material include textiles such as cotton or inflexible polymers. It is preferred that the material of the inflatable body support enclosure 10 is strong and able to resist a large amount of pressure or other force. While the side 18 and bottom 14 panels of the inflatable body support enclosure 10 are intended to be constructed out of a strong material, it is contemplated that the top panel 12 of the inflatable body support enclosure 10 may be constructed of a softer inflexible material for increased comfort.

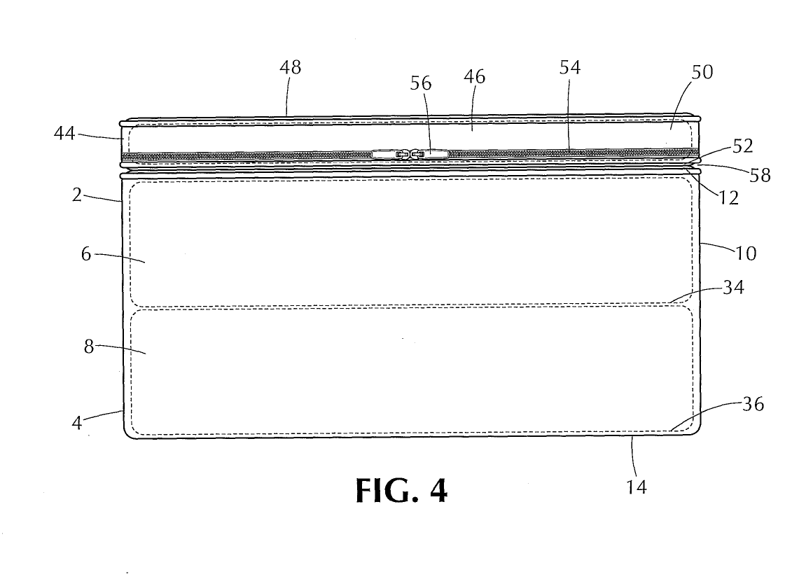

The first inflatable mattress 6 is placed near the top of the inflatable body support enclosure and the second Inflatable mattress 8 is placed near the bottom of the inflatable body support enclosure 10. The second inflatable mattress 8 preferably has a length and width substantially similar to the length and width of the first inflatable mattress 6. As illustrated in FIGS. 1 and 4, the first and second inflatable mattresses 6, 8 are in an overlying abutting relationship to each other within the inflatable body support enclosure 10. The inflatable body support enclosure 10 has first and second valve openings 20, 22 aligned with the first and second inflation valve 26, 28 on the first and second inflatable mattress 6, 8 to allow a user to access the second inflation valve when it is inside the cover 4.

The first and second inflatable mattresses 6, 8 each have a top 30, 32, and bottom panel 34, 36, four side panels, 38, 40 and a first and second inflation valve 26, 28, which allow the mattresses to receive water, air or another gas or fluid from an inflation source. The inflatable mattresses 6, 8 are substantially rectilinear in shape when in an inflated state. The inflation valves 26, 28 of the mattresses are preferably on a side panel 38, 40 of the mattress.

The interior volume of the inflatable body support enclosure 10 of the cover 4 is substantially equal to or smaller than a maximal combined unhindered inflated volume of the inflatable body support comprising the one or more inflatable mattresses 6, 8. This causes the cover 4 to form an inflatable body confining volume which restricts expansion of the inflatable body support. The confining volume provided by the inflatable bed support enclosure 10 allows the inflatable mattresses to receive a large amount of air pressure when the mattresses 6, 8 are fully inflated, while maintaining their structural integrity. This causes the inflatable bed to provide a level of support that is more firm than if expansion of the inflatable body support was unhindered.

As shown in FIG. 4, when the one or more mattresses 6, 8 are fully inflated inside the inflatable body support enclosure 10, the opposite ends of the slit 24 separate and the slit becomes narrow and elongated, substantially closing the slit. The substantially closed elongated slit 24 protects the first and second mattresses 6, 8 and maintains their position inside the mattress cover 4. In another embodiment, sealing means may be used along the elongated slit 24, such as a zipper or hook-and-loop fastener, or another type of fastener, to provide further securing of the slit and protection of the mattresses 6, 8. Further, the slit 24 may be located on a seam between two of the panels of the cover 4.

While the inflatable bed 2 preferably comprises two inflatable mattresses 6, 8, it is contemplated that the inflatable body support may consist 10 of a single inflatable mattress disposed within the inflatable body support enclosure 10, which single inflatable mattress has a single inflation valve aligned with a single inflation valve opening on the inflatable body support enclosure 10.

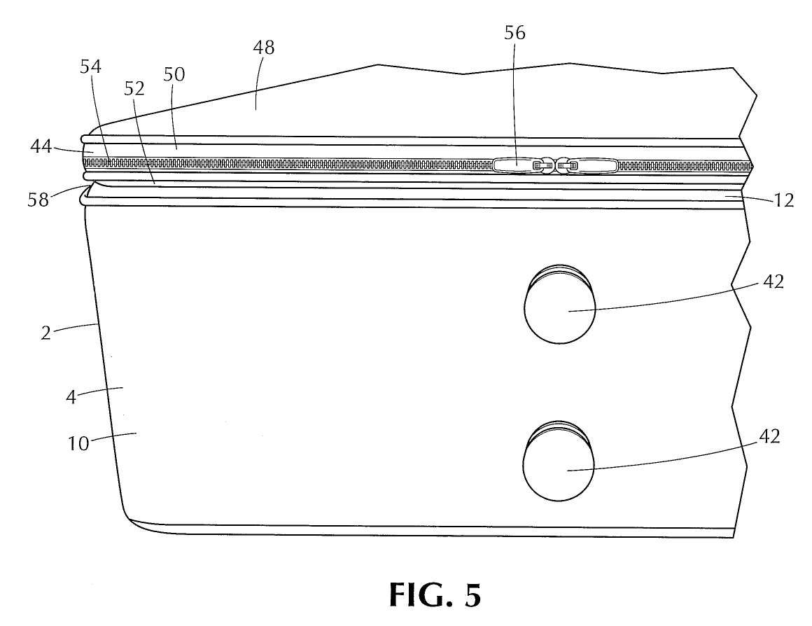

After the user is finished inflating the inflatable body support, the user may fasten covers 42 on the inflation valve openings 20, 22. As shown in FIG. 5, the inflation valve opening covers 42 are preferably contoured to sufficiently protect the mattresses 6, 8, from being damaged or soiled and to provide an attractive appearance for the inflatable bed 2.

In order to enhance the comfort level of the inflatable bed assembly 2, it is preferred that a mattress padding enclosure 44, is attached to the top panel 12 of the inflatable body support enclosure 10. The mattress padding enclosure 44 holds padding 46 such as memory foam, an inflatable body, or cotton, down, polyester, or other materials known in the art. The mattress padding enclosure 44 has a top panel 48 and four side panels 50, and has dimensions approximately equal to the top panel 12 of the inflatable body support enclosure. The mattress padding enclosure 44 may also have a bottom panel 52.

The mattress padding enclosure 44 has a selectively closeable opening 54 having a length suitable to permit insertion and removal of the padding 46. In embodiments where the mattress padding enclosure 44 does not have a bottom panel 52, it is preferable that the selectively closeable opening 54 extends around the entire circumference of the mattress padding enclosure 44 so that the selectively closeable opening releasably attaches the mattress padding enclosure to the first inflatable body support enclosure 10.

In embodiments where the mattress padding enclosure 44 has a bottom panel 52, the bottom panel is releasably attached to the top panel 12 of the inflatable body support enclosure by fastening means. The fastening means may be a zipper, snap buttons, velcro, or other fasteners well known in the art. In this embodiment, it is preferable that the mattress padding enclosure 44 has a selectively closeable opening 54 at three edges to allow bulky mattress padding to be easily inserted and removed.

The combination of the soft padding 46 on the top portion of the inflatable bed 2 with the firm support provided by the inflatable body support within the mattress cover 4 creates an extremely comfortable inflatable bed that provides firm support equal to the support provided by high quality traditional mattresses. The novel inflatable bed is suitable for everyday use and is more cost effective and portable as compared to other prior art beds.

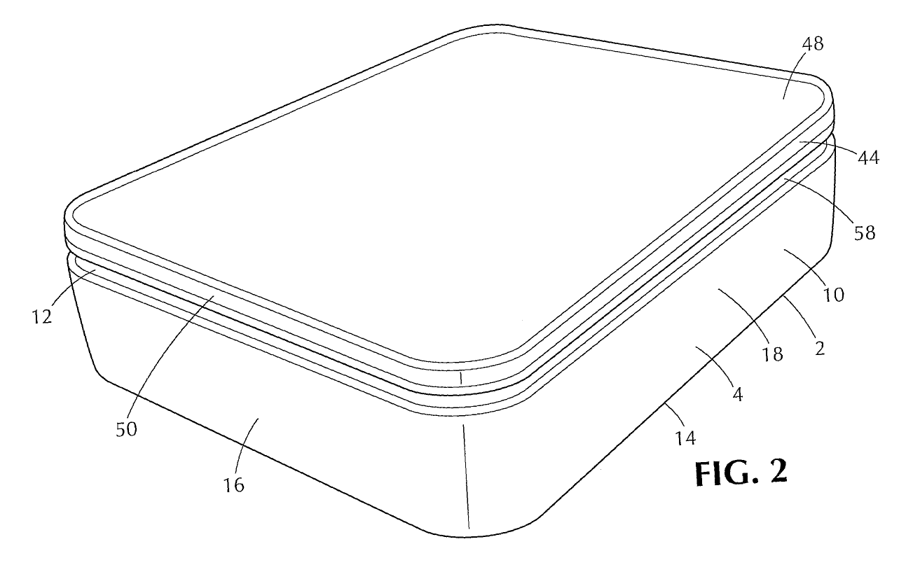

As shown in FIG. 2, the inflatable bed assembly also provides an attractive appearance similar to the aesthetics of a high quality traditional bed. The fastener 56 of the padding cover is preferably offset from the outermost periphery of the side panel 18 of the inflatable body support enclosure and the side panel of the padding cover 54 to create a circumferential indentation 58 or groove which provides the inflatable bed with the appearance of a two-layered, pillow-top construction on a traditional mattress. The inflation valve opening covers 42 increase the attractiveness of the inflatable bed 2 by hiding the inflation valve openings 20, 22 and conveying an impression of continuity along the mattress cover sides.

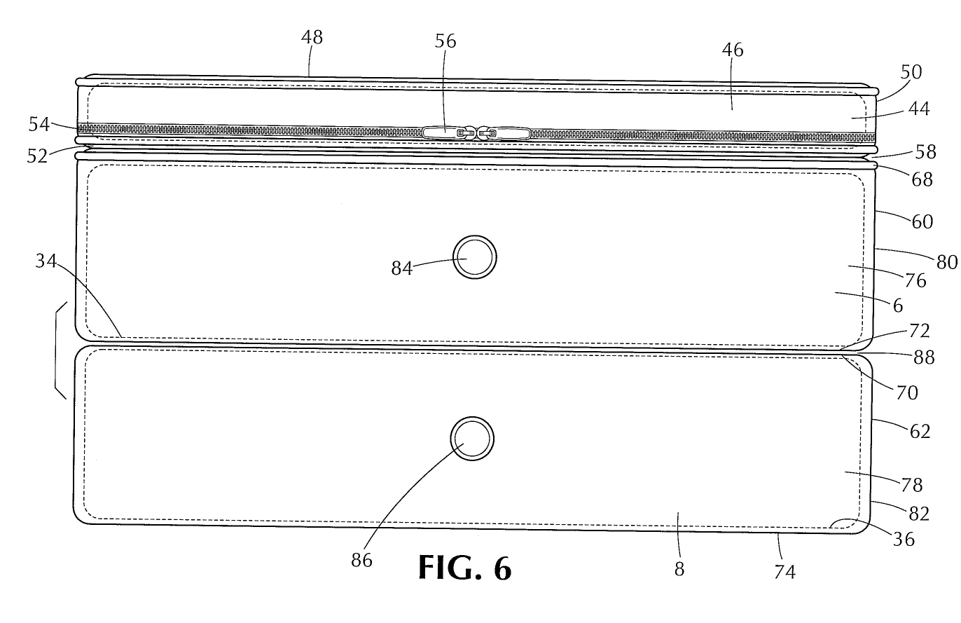

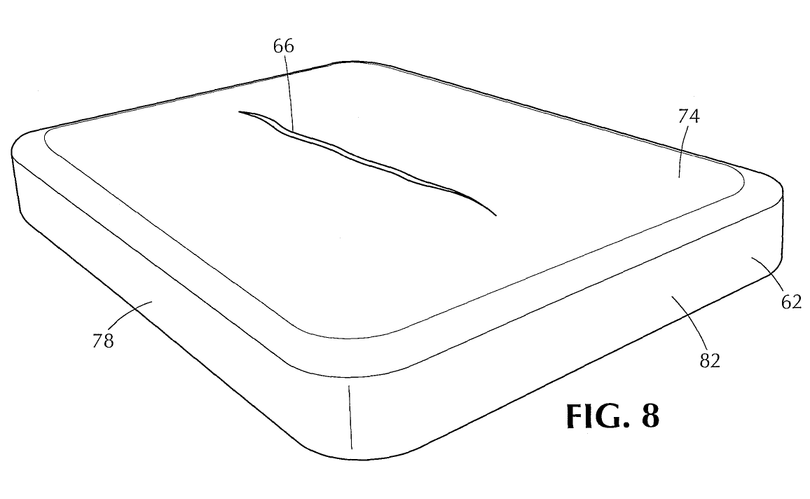

Referring to FIGS. 6-8, in a second embodiment, the cover 4 has first and second inflatable body support enclosures 60, 62, which are preferably releasably interconnected through fastening means well known in the art such as hook-and-loop fasteners, zippers, buttons, or snaps. The first and second inflatable mattresses 6, 8 are inserted into the first and second inflatable body support enclosures 60, 62, respectively. The first and second inflatable body support enclosures each have a top 68, 70 and bottom 72, 74 panel, first and second side panels 76, 78, first and second opposed end panels 80, 82, and a first and second inflation valve opening 84, 86. The first and second inflatable body support enclosures 60, 62 also each have an elongated slit 64, 66 on the bottom panel 72, 74 that is large enough to permit the insertion and removal of one or more inflatable mattresses in a fully deflated or nearly fully deflated state. FIG. 8 shows the elongated slit 66 on the bottom panel of the second enclosure.

The panels on the first and second inflatable body support enclosures 60, 62 are constructed of an inflexible material that is strong and able to resist a large amount of pressure or other force, such as the materials described above. The first and second inflation valves 26, 28 on the first and second inflatable mattresses 6, 8 are aligned with the first and second inflation valve opening 84, 86 to give the user access to the first and second inflation valve when the first and second inflatable mattresses 6, 8 are inside the cover 2.

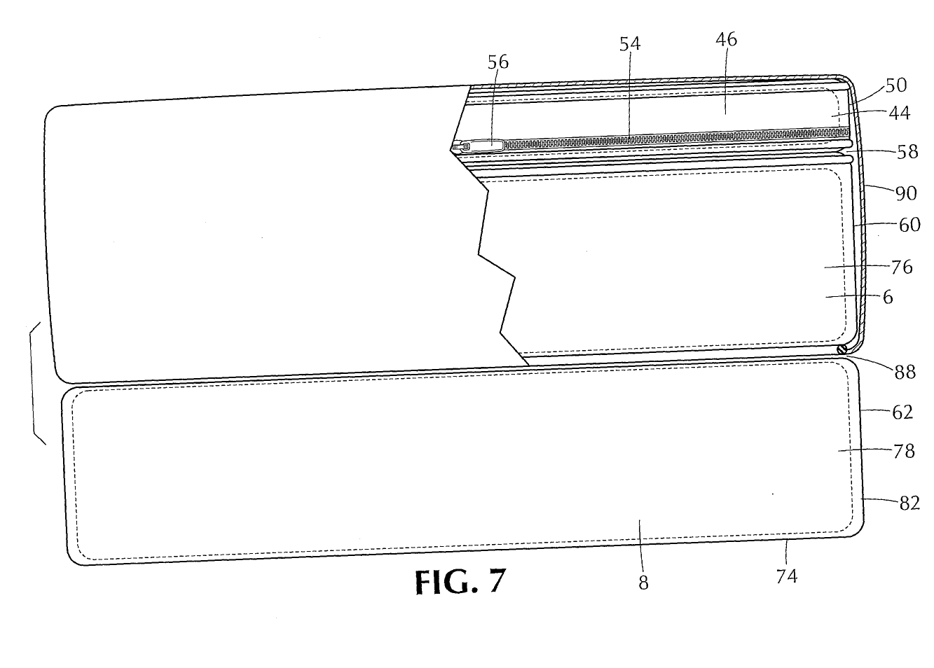

The inflatable bed preferably has a channel 88 around a periphery of a side of the cover 4. The channel 88 may be formed between the first and second inflatable body support enclosures 60, 62. As shown in FIG. 7, the channel 88 permits a fitted sheet 90 with an opening and an elastic closure to be placed over the cover 4, with the elastic closure disposed in the channel 88.

As described above, the interior volume of the first and second inflatable body support enclosures 60, 62 are each substantially equal to or smaller than an unhindered inflated volume of the first and second inflatable mattresses 6, 8, respectively, which provides a firm level of support.

Also, as above, opposite ends of the slits 64 and 66 of the first and second inflatable body support enclosures 60, 62 separate when the inflatable body support enclosures 60, 62 are inflated to substantially close the slits 64, 66.

Each of the first and second inflatable body support enclosures 60, 62 include a cover 42, which may be placed over one of the first and second inflation valve openings.

Further, a mattress padding enclosure 44 and padding 46 may be provided as described above, to provide increased comfort. Preferably, the mattress padding enclosure 44 is connected to the top panel of the first inflatable body enclosure 60.

As depicted, it is preferable that the (releasably interconnected) first and second inflatable body support enclosures 60, 62 each comprise six panels, with the bottom panel 72 of the first inflatable body support enclosure 60 and the top panel 70 of the second inflatable body support enclosure 62 interposed between the first and second inflatable mattresses 6, 8 in an adjacent and abutting relationship. However, it is contemplated that the bottom panel 72 of the first inflatable body support enclosure 60 or the top panel 70 of the second inflatable body support enclosure 62 can be omitted such that one of the first and second inflatable body support enclosures 60, 62 consists of five panels. In this construction, the panel interposed between the first and second mattresses 6, 8 provides structural support for both the first and second inflatable body support enclosures 60, 62. It can be appreciated that the five-panel inflatable body support enclosure would be interconnected to the six-panel inflatable body support enclosure prior to full inflation of the inflatable mattress within the five-panel inflatable body support enclosure.

While the embodiments above depict a plurality of two inflatable mattresses, it is contemplated that the inflatable body support can comprise more than two inflatable mattresses. Further, when a plurality of inflatable mattresses are used for the inflatable body support, the top inflatable mattress 6 preferably has support projections on its top surface for increased comfort, and the bottom inflatable mattress 8 may have I-beams or other support structures for stability. When the inflatable body support comprises a single inflatable mattress, the single inflatable mattress preferably combines the support and comfort provided by separate first and second mattresses 6, 8. Alternatively or additionally, a plurality of inflatable mattresses may be arranged in a row, in a horizontally abutting relationship with each other.

It should be understood, of course, that the specific form of the invention herein illustrated and described is intended to be representative only, as certain changes may be made therein without departing from the clear teachings of the disclosure. Accordingly, reference should be made to the following appended claims in determining the full scope of the invention.

What is claimed is:

1. An inflatable bed, comprising:
an inflatable body support, including a first inflatable mattress;
said first inflatable mattress having top and bottom panels, first and second opposed side panels, first and second opposed end panels, and a first valve, and having a substantially rectilinear shape when in an inflated state;
a cover having a first inflatable body support enclosure;
said first inflatable body support enclosure having top and bottom panels, first and second opposed side panels, first and second opposed end panels, a first valve access opening,
means to insert and remove said first inflatable mattress into and from said first inflatable body support enclosure having a length suitable to permit insertion and removal of said inflatable body support therethrough;
said first inflatable mattress being disposed within said first inflatable body support enclosure and being in said inflated state;
said first valve being aligned with and accessible through said first valve access opening of said first inflatable body support enclosure, from an exterior of said inflatable bed; and
said panels of said first inflatable body support enclosure being in tension.

2. An inflatable bed, as in claim 1, further comprising:
a mattress padding sized and shaped to substantially cover a top surface of said inflatable body support;
said cover including a mattress padding enclosure affixed to said first inflatable body support enclosure and having a selectively closeable opening having a length suitable to permit insertion and removal of said mattress padding therethrough; and
said mattress padding being below said top panel of said mattress padding enclosure, when said mattress padding is inserted into said cover.

3. An inflatable bed, as in claim 1, wherein:
said inflatable body support has a maximal unhindered inflated volume when fully inflated outside said cover;
when said first inflatable body support is in an inflated state within said first inflatable body support enclosure, said first inflatable body support enclosure defines a volume less than said maximal unhindered inflated volume of said inflatable body support; and
said panels of said first inflatable body support enclosure are substantially inelastic and prevent inflation of said inflatable body support to said maximal unhindered inflated volume, when said inflatable body support is in said inflated state within said first inflatable body support enclosure.

4. An inflatable bed, as in claim 1, wherein:
said inflatable body support further comprises a second inflatable mattress having a length and width substantially similar to a length and width of said first inflatable mattress, and having a second valve;
said cover having a second valve access opening;
said second inflatable mattresses being stacked below said first inflatable mattress within said cover and said first and second inflatable mattresses being in said inflated states within said cover; and
said first and second valves being aligned with and accessible through said first and second valve access openings, respectively, from an exterior of said inflatable bed.

5. An inflatable bed, as in claim 4, wherein:
said second inflatable mattress has top and bottom panels, first and second opposed side panels, and first and second opposed end panels, and has a substantially rectilinear shape when in said inflated state;
said cover further comprises a second inflatable body support enclosure;
said second inflatable body support enclosure has a bottom panel, first and second opposed side panels, and first and second opposed end panels;
said second valve access opening being disposed on one of said panels of said second inflatable body support enclosure;
said second inflatable mattress being disposed within said second inflatable body support enclosure;
said panels of said second inflatable body support enclosures are in tension; and
said second inflatable body support enclosure is releasably attached to said first inflatable body support enclosure.

6. An inflatable bed, as in claim 5, further comprises:
means to insert and remove said second inflatable mattress into and from said second inflatable body support enclosure.

7. An inflatable bed, as in claim 5, further comprising:
said inflatable bed having a channel around a periphery of a side of said inflatable bed, said channel being formed between said first and second inflatable body support enclosures;
a fitted sheet having an opening with an elastic closure; and
said fitted sheet being fitted over said first inflatable body support enclosure with said elastic closure of said opening of said fitted sheet disposed in said channel.

8. An inflatable bed, as in claim 6, further comprising:
said inflatable bed having a channel around a periphery of a side of said inflatable bed, said channel being formed between said first and second inflatable body support enclosures;
a fitted sheet having an opening with an elastic closure; and
said fitted sheet being fitted over said first inflatable body support enclosure with said elastic closure of said opening of said fitted sheet disposed in said channel.

9. An inflatable bed, as in claim 5, wherein a top panel of said second inflatable body support enclosure comprises said bottom panel of said first Inflatable body support enclosure.

10. An inflatable bed, as in claim 5, wherein said bottom panel of said first inflatable body support enclosure comprises said top panel of said second inflatable body support enclosure.

11. A method for assembling an inflatable bed, comprising the steps of:
inserting an inflatable body support including a first inflatable mattress having a first valve into a first inflatable body support enclosure of a cover;
aligning said first valve with a first valve opening of said first inflatable body support enclosure; and
inflating said first inflatable mattress within said first inflatable body support enclosure through said first valve opening.

12. A method for assembling an inflatable bed, as in claim 11, further comprising the step of:
inflating said first inflatable mattress with an amount of air that would inflate said first inflatable mattress in an unhindered state past a volume of said first inflatable body support enclosure.

13. A method for assembling an inflatable bed, as in claim 11, further comprising the steps of:
attaching a mattress padding enclosure to a top panel of said first inflatable body support enclosure, said mattress padding enclosure having a selectively closeable opening having a length suitable to permit insertion and removal of a mattress padding;
opening said selectively closeable opening;
inserting said mattress padding within said mattress padding enclosure; and
closing said closeable opening on said mattress padding enclosure.

14. The method for assembling an inflatable bed, as in claim 11, further comprising the steps of:
inserting a second inflatable mattress having a second valve into said cover;
positioning said second inflatable mattress below said first inflatable mattress;
aligning said second valve with a second valve opening of said cover; and
inflating said second inflatable mattress within said cover through said second valve opening.

15. The method for assembling an inflatable bed, as in claim 14, further comprising the steps of:
inflating said first and second inflatable mattress with amounts of air that would inflate said first and second inflatable mattresses in an unhindered state to a combined volume that is greater than a volume of said cover.

16. A method for assembling an inflatable bed, comprising the steps of:
inserting an inflatable body support including a first inflatable mattress having a first valve into a first inflatable body support enclosure of a cover;
aligning said first valve with a first valve opening of said first inflatable body support enclosure;
attaching a second inflatable body support enclosure to said first inflatable body support enclosure;
inserting a second inflatable mattress having a second valve into said second inflatable body support enclosure;
aligning said second valve with a second valve opening of said second inflatable body support enclosure;
inflating said first inflatable mattress within said first inflatable body support enclosure through said first valve opening; and
inflating said second inflatable mattress within said second inflatable body support enclosure through said second valve opening.

17. A method for assembling an inflatable bed, as in claim 16, further comprising the step of:
inflating said first inflatable mattress with an amount of air that would inflate said first inflatable mattress in an unhindered state to a volume greater than a volume of said first inflatable body support enclosure; and
inflating said second inflatable mattress with an amount of air that would inflate said second inflatable mattress in an unhindered state to a volume greater than a volume of said second inflatable body support enclosure.

18. A method for assembling an inflatable bed, as in claim 16, further comprising the steps of:
attaching a mattress padding enclosure to a top panel of said first inflatable body support enclosure, said mattress padding enclosure having a selectively closeable opening having a length suitable to permit insertion and removal of a mattress padding;
opening said selectively closeable opening;
inserting said mattress padding within said mattress padding enclosure; and
closing said closeable opening on said mattress padding enclosure.

19. A method for assembling an inflatable bed, as in claim 16, further comprising the step of:
said inflatable bed having a channel around a periphery of a side of said inflatable bed between said first and said second inflatable body support enclosures; and
attaching a fitted sheet having an opening with an elastic closure over said first inflatable body support enclosure, with said elastic closure disposed in said channel.
